(19) United States
(12) Patent Application Publication
(10) Pub. No.: US 2013/0052448 A1
(43) Pub. Date: Feb. 28, 2013

(54) Process for the Production of Fiber Reinforced Thermoplastic Composites

(71) Applicant: Hans Korte, Wismar (DE)

(72) Inventor: Hans Korte, Wismar (DE)

(21) Appl. No.: 13/696,539

(22) PCT Filed: May 19, 2011
(86) PCT No.: PCT/EP2011/002495

§ 371 Date: Nov. 13, 2012

(30) Foreign Application Priority Data
May 21, 2010 (DE) 10 2010 022 186.4

(51) Int. Cl. C08L 23/10; C08L 1/08; C08L 77/00; B32B 5/16; C08L 97/02

(52) U.S. Cl. 428/220; 428/402; 524/9; 524/538; 524/35

(57) ABSTRACT

A process for the production of fiber-reinforced thermoplastic compounds characterized in that fiber agglomerates and thermoplastic resins are compounded discontinuously with internal kneaders whereby fiber agglomerates are dispersed into single fibers and the single fibers are distributed homogeneously in the thermoplastic matrix.

This invention relates to the production of composites from dispersed fiber agglomerates and thermoplastic resins which are compounded using an internal mixer.

The reinforcement of thermoplastic resins with fibers, mostly with short glass fibers is state of the art. A precondition for compounding in typical plastic processing machinery, e.g. with twin screw extruders is a good dosing behavior of the fibers. For glass fibers dosing behavior is fine but with other fibers, e.g., natural fibers or organic based synthetic fibers which tend to entangle or agglomerate due to adhesion, interlock, or entanglement of the fibers, dosing is hard to realize. For this reason, so called long fiber granulates are produced, e.g. by pulltrusion (see e.g. AT 411 661; UK 1 439 327; U.S. Pat. No. 5,725,954; 3,993,726). The pulltrusion process uses a bundle of fibers which are pushed or pulled through a die and thereby are impregnated and/or enveloped by molten polymer. The throughput speed of several meters per minute is relatively slow and the total throughput additionally is low due to the fact that only one fiber bundle can be impregnated per die. In case granulate shall be produced in typical dimensions used in injection molding, the diameter of the finished compound strand should not exceed 6-10 mm in order to be fed into the extruder screws without problems.

DE 10 2005 040 620 describes the production of glass fiber reinforced polymer compositions. According to the figure and its description stating that “this means that glass or other fibers . . . continuously are treated by the wetting or impregnation process”, this process resembles a pulltrusion process even if for the compounding the “typical machinery like internal mixers, extruders and twin screws . . . ” are named. The product is described as long-fiber granulate with unidirectionally aligned filaments which excludes a direct kneading of the fibers within the plastic matrix. As alternatives to pulltrusion, textile processes have been presented in recent times to produce long-fiber granulates (DE 197 11 247; EP 1 097 033). In principle, these processes use a combination of reinforcing fibers and thermoplastic fibers twisted together to a thick yarn which is fused to form a stable strand by melting the thermoplastic fibers; and after cooling the strand is cut to granulate size. These textile processes are faster but they also only produce one strand (of 6-10 mm) per unit. The use of “bonding fibers” which have to be produced in an upstream process additionally increases the cost of this process.

An objective of the present invention is to offer a process to produce fiber-reinforced thermoplastic composites in large quantities at relatively low cost. The problem is solved by a process for the production of fiber-reinforced thermoplastic composites which is characterized by discontinuously compounding fiber agglomerates and thermoplastic resins in internal kneaders whereby the fiber agglomerates are dispersed into single fibers which are homogeneously distributed. The use of fiber agglomerates helps to reduce cost because fiber agglomerates from production wastes or from fiber pulps which often are made from recycling material can be used.

An essential difference between kneading technology and compounding with twin screw extruders (TSE) is that kneaders work discontinuously but TSE work continuously. In continuous processes, gravimetric dosing of all components is an essential precondition for obtaining compounds having uniform composition. Because fibers tend to entangle, a continuous exact gravimetric dosing is very difficult. Kneaders used in rubber industry do not have this problem as they work discontinuously. Before starting the kneading process, the kneader is fed with balanced proportions of the recipe. After starting the process, additional components may be added during the kneading process, if necessary. After a certain time corresponding to a given recipe, the kneading process is terminated by opening a valve whereby the kneaded substance is ejected. The material leaving the kneader consists of one or more pieces of compound which either are formed in calenders into panels or sheets, e.g. with a thickness of from 0.2 mm to 15 mm, preferably 0.5 mm to 10 mm, more preferably from 1 to 6 mm, or granulated in special TSE to granulates of from 2 mm to 15 mm, preferably 3 mm to 8 mm, and more preferably from 4 mm to 6 mm. The TSE is not comparable to the above-mentioned TSE which has to melt thermoplastics, but is a continuously working, counter-rotating dosing device which is able to press the hot thermoplastic compound through a die plate with a number of holes for subsequent granulation.

Internal mixers of Harburg Freudenberg AG are able to compound several tons per hour of rubber or thermoplastic composites, respectively, reaching industrial scales which are not achievable with the above-mentioned pulltrusion devices. When using kneading technology for producing thermoplastic compounds it has been unexpectedly found that even fibers which are difficult to dose and difficult to disperse, like entangled long-fibers or fiber pulps, can be homogeneously distributed in thermoplastic matrices. In this context, the term long-fibers means fiber agglomerates of biological, mineral or organic, natural or synthetic origin with fiber lengths greater than 30 mm, preferably greater than 50 mm, which are present in a disordered three dimensional entangled form. Thereby they differentiate themselves essentially from long-fibers in fiber-oriented arrangement, e.g. yarns, rowings or teasels which are used for pulltrusion processes. Pulps are fibers highly fibrillated by milling. Such pulps are mainly known from pulp and paper industry, but are also produced from aramid, preferably from para-aramid (p-aramid), polyacrylnitrile (PAN) or cellulose fibers from hemp, flax or lyocell (e.g. Tencel®). Additional useful cellulose fibers are viscose and rayon fibers (e.g. Cordenka®). Due to their high degree of fibrillation, pulps have a high tendency to entangle their individual fibers. The degree of fibrillation can be defined, e.g., by the value of the specific surface area. For instance, short fibers from para-aramid filaments with a nominal diameter of 13 μm show a specific surface area of 0.2 m²/g (U.S. Pat. No. 4,957,794). Typical diameters of synthetic fibers range between 10 and 20 μm, not excluding lower or higher values. Pulps made from p-aramid with starting fiber diameters of 13 μm show specific surface areas of 6-16 m²/g, and pulps from PAN of up to 50 m²/g and more. The average diameters of p-aramid fibrils thus are smaller by a factor of 30 to 80, compared to the starting fibers. They achieve sub-micron dimensions of calculated 0.16 pm to 0.43 μm. Fiber lengths range from 1 to 6 mm, depending on fiber type and degree of milling. In PAN pulps, the fiber fibrils show average diameters of 0.07 μm, which means that the fibrils are 190 times smaller than the starting fibers prior to milling.

One embodiment of the invention uses fiber agglomerates from fibrillated fiber bundles of starting fibers with a diameter before fibrillation of 10 to 20 μm, and fibrils (after fibrillation) which are smaller by a factor of 5 to 250, preferably by a factor of 10 to 200, and more preferably by a factor of 30 to 80, compared to the starting fibers.

In one embodiment of the invention, the fibrillated fiber bundles show a specific surface area (determined by DIN ISO 9277:2003-05 “Determination of the specific surface area of solids by gas adsorption according to the BET process (ISO 9277:1995)”) of from 1.0 to 60 m²/g, preferably from 6 to 50 m²/g, and more preferably from 8 to 16 m²/g.

The invented process preferably uses non-coated fibers. Due to the fact that fibrillated fiber bundles or fiber pulps, respectively, usually are produced by milling in water, coatings used in the spinning process (avivages) and potentially still present on the fibers are washed off before the fibers are used in the inventive process.

In one embodiment of the invention, the thermoplastic resins are selected from the material group comprising polyolefins, e.g., polyethylene (PE) or polypropylene (PP) and their co-polymers; polyamides (PA) and their co-polymers; styrenic polymers, e.g., polystyrene (PS), acrylonitrile-butadiene-styrene (ABS), acrylic ester-styrene-acrylonitrile (ASA) and their co-polymers; cellulose derivatives, e.g. cellulose acetate (CA); polyesters, e.g., polyethylene terephthalate (PET) and its co-polymers; polymethacrylates, e.g., polymethyl methacrylate (PMMA); bio-polymers, e.g., polylactic acid (PLA), or mixtures of two or more polymers.

The working principle of an internal kneader is characterized by two kneading elements which roll around the material between themselves and the surrounding housing whereby, caused by the geometry of the kneading elements, peak pressure phases alternate with load relieving phases. Thus the material is sheared and friction heat is generated within a short time, heating the kneaded material rapidly. Sophisticatedly constructed kneaders contain kneading elements with an internal cooling device which enables to avoid local overheating of the kneaded material by appropriate control of the temperature regime. By regulating revolutions per minute and temperature, the heating rate can be controlled. With a kneader, several functions which are of interest in compounding, especially in compounding wet natural fibers, can be combined. These functions like mixing, homogenizing, shortening of fibers, drying and heating up to or above the melting point of the thermoplastic resin and, if necessary, squeezing thermoplastic matrix material into voids of the cell structure of the fiber material are given different weight depending on the respective process an allow for optimization of the compounds corresponding to the recipe. Fiber content in compounds may vary from 3% to 80% by weight, preferably from 10% -50%, and more preferably from 15% to 35%.

In one embodiment of the invention, from 1 to 5% by weight of bonding agent is added to the mixture of thermoplastic resins and fibers.

In another embodiment of the invention, kneading time is from 2 to 30 minutes, e.g. 4 to 10 minutes.

In one embodiment of the invention, the tensile E-modulus increases at least by 25%, preferably by 50%, and more preferably by 100%, compared to the unmodified thermoplastic resin; and impact strength is increased by a factor of from 1.1 to 10, preferably by a factor of from 1.2 to 8, and more preferably by a factor of from 2 to 5.

### EXAMPLES

### Example 1

30.6 kg of material containing 30 parts by weight long-fiber hemp (BaFa Badische Naturfaser GmbH, Type VF6) with 8% moisture, 70 parts by weight polypropylene (Clyrell EM 248U) and 2 parts by weight maleic acid anhydride grafted polypropylene as bonding agent (Exxelor PO 1020) were dosed together into an internal mixer (Harburg Freudenberger type 45) and kneaded for 5 minutes at 190 revolutions per minute. The kneaded mixture was transferred into a conical, counter-rotating twin screw extruder and pressed through a die containing multiple holes with hole diameters of 10 mm. Downstream of the die, the material was granulated to pellets by means of underwater granulation equipment. Granulates were dewatered in a centrifuge and further cooled on a vibrating trough before packaging. The resulting long-fiber granulates were injection-molded into test samples (dog bones) on an injection molding unit (Arburg 420 C). The test samples were analyzed for tensile E-modulus, tensile strength, tensile elongation (according to DIN EN ISO 527/1/2/3) and for impact strength (according to DIN EN ISO - 179-1) (see Table 1).

### Example 2

Concentrations and processing were as in Example 1. Short hemp fibers (BaFA Badische Naturfaser GmbH, Type KFS, fein) were used instead of long-fibers.

### Example 3

Concentrations and processing were as in Example 1. Fiber pulp (BaFa Badische Naturfaserpulpe GmbH, Type SKF 2) was used instead of long-fibers.

### Example 4

Fiber starting material was 10 parts by weight p-aramid pulp (Teijin AG, Twaron 1095) and 90 parts by weight polyamide 6 (Ravamid R 200 S) without bonding agent. Kneading time was increased to 7 minutes to reach and slightly exceed the melting point of PA 6 of 240° C. Pelletizing and testing as in Example 1.

TABLE 1
Tensile strength and impact resistance of 3 kneaded mixtures
of PP with hemp fibers and a mixture of PA 6 and p-aramid pulp.

| | Thermo- | Fiber | Tensile | | | |
|---|---|---|---|---|---|---|
| | plastic | con- | E- | Tensile | Elon- | Impact |
| Reinforcing | matrix | tent | modulus | strength | gation | strength |
| fiber | resin | [%] | [MPa] | [MPa] | [%] | [kJ/m²] |
| — | PP | 0 | 950 | 26 | >50 | 8 |
| hemp long- | PP | 30 | 2543 | 31 | 6 | 11 |
| fiber | | | | | | |
| hemp short- | PP | 30 | 2290 | 27 | 5 | 8 |
| fiber | | | | | | |
| hemp pulp | PP | 30 | 1613 | 23 | 8 | 10 |
| — | PA6 | 0 | 3200 | 83 | 20 | 5.5 |
| aramid pulp | PA6 | 10 | 3617 | 72 | 8 | 27 |

As can be seen from Table 1, the tensile E-moduli are increased up to 270% by incorporating fibers and fiber pulps. Tensile strengths vary from a slight decrease to a slight increase. Tensile elongation is strongly reduced and impact resistance is slightly increased in hemp-PP-compounds by a factor of 1.25 up to 1.37, but is increased up to almost a factor of 5 in the PA 6-aramid-compound.

### Example 5

Fibers, polypropylene and bonding agent were dosed together into the internal kneader (Harburg Freudenberger Type GK 5 E, filling volume 5.5 1) according to table 2. They were kneaded at 136 revolutions per minute until at least melting temperature of PP of 166° C. was reached. After reaching the melting temperature, revolutions per minute were reduced and the mixture was kneaded for further 6 to 10 minutes. The kneading mixture was discharged in one piece and was split by hand into pieces of about 5 cm in diameter and 15 to 25 cm length. After cooling, the pieces were granulated on a cutting mill equipped with a sieve with 5 mm holes. The resulting granulate was injection-molded (Arburg 420 C) to test pieces (dog bones). The test pieces were measured for tensile E-modulus, tensile strength, tensile elongation and impact strength (see Table 3).

TABLE 2

| | Loading | | Concen- | | Concen- | | Concen- |
|---|---|---|---|---|---|---|---|
| Trial | content | | tration | | tration | | tration |
| number | [%] | Polymer | [%] | Fiber type | [%] | Bonding agent | [%] |
| 1 | 75 | PP Homo HC205TF MFR 4 | 68 | STW Lyocell Pulp PLY VZL | 30.00 | Scona TPPP | 2 |
| | | (density 0.905 g/cm³) | | | | 8112 FA | |
| 2 | 75 | PP Homo HC205TF MFR 4 | 88 | STW Lyocell Pulp PLY VZL | 10.00 | Scona TPPP | 2 |
| | | | | | | 8112 FA | |
| 3 | 75 | PP Homo HC205TF MFR 4 | 68 | Lenzing Tencel FCP | 30.00 | Scona TPPP | 2 |
| | | | | 10/490 | | 8112 FA | |
| 4 | 75 | PP Homo HC205TF MFR 4 | 88 | Lenzing Tencel FCP | 10.00 | Scona TPPP | 2 |
| | | | | 10/490 | | 8112 FA | |
| 5 | 75 | PP Homo HC205TF MFR 4 | 68 | Lenzing-Viscose | 30.00 | Scona TPPP | 2 |
| | | | | short-fiber 6 mm 1.4 dn | | 8112 FA | |
| 6 | 75 | PP Homo HC205TF MFR 4 | 88 | Lenzing-Viscose | 10.00 | Scona TPPP | 2 |
| | | | | short-fiber 6 mm 1.4 dn | | 8112 FA | |
| 14 | 75 | PP Homo HC205TF MFR 4 | 68 | Rayon, Cordenka 1840 | 30.00 | Scona TPPP | 2 |
| | | | | f1000 RT7f | | 8112 FA | |
| | | | | fiber length 30-50 mm | | | |
| 15 | 75 | PP Homo HC205TF MFR 4 | 88 | Cordenka 1840 f 1000 RT | 10.00 | Scona TPPP | 2 |
| | | | | 700 Twist 100 | | 8112 FA | |
| 17 | 75 | PP Copo Clyrell EM248U | 68 | Lenzing-Viscose | 30.00 | Scona TPPP | 2 |
| | | MFR 70 | | short-fiber 12 mm 1.7 dn | | 8112 FA | |
| 18 | 75 | PP Copo Clyrell EM248U | 88 | Lenzing-Viscose | 10.00 | Scona TPPP | 2 |
| | | MFR 70 | | short-fiber 12 mm 1.7 dn | | 8112 FA | |

TABLE 3

| | Results | | | | | | | | | |
|---|---|---|---|---|---|---|---|---|---|---|
| | | | | | | | Impact 23° C. | | | |
| | Tensile | | | | | | | | Charpy | |
| | strength | | Modulus* | | Elongation | | Charpy unn. | | n. | |
| | [MPa] | | [GPa] | | [%] | | [kJ/m²] | | [kJ/m²] | |
| Material | Average | STD | Average | STD | Average | STD | Average | STD | Average | STD |
| Sample 1 | 52 | 1.6 | 2.64 | 0.03 | 5.2 | 0.7 | 36.1 | 1.4 | 3.5 | 0.2 |
| Sample 2 | 39.7 | 0.1 | 1.95 | 0.01 | 9 | 1.5 | 76.7 | 9.9 | 2.7 | 0.3 |
| Sample 3 | 59.7 | 0.2 | 2.9 | 0.01 | 7.2 | 0.3 | 40.3 | 4.1 | 4.8 | 0.4 |
| Sample 4 | 41 | 0.1 | 2 | 0.01 | 13.7 | 2 | 58.2 | 1.8 | 3.9 | 0.3 |
| Sample 5 | 51 | 0.1 | 2.9 | 0.1 | 4.4 | 0.3 | 24.3 | 0.6 | 3.7 | 0.4 |
| Sample 6 | 38.8 | 0.1 | 2 | 0.02 | 7.7 | 0.6 | 39.1 | 3 | 2.5 | 0.1 |
| Sample 15 | 50.2 | 0.1 | 1.98 | 0.02 | 11.9 | 0.5 | 58 | 4.7 | 5.1 | 0.5 |
| Sample 17 | 47.7 | 0.6 | 2.37 | 0.04 | 6.4 | 0.4 | 34.9 | 3.9 | 5.6 | 0.2 |
| Sample 18 | 30.2 | 0.1 | 1.29 | 0.1 | 15.3 | 2.4 | n.d. | / | 3.6 | 0.8 |

| | Results | | | | | | | | |
|---|---|---|---|---|---|---|---|---|---|
| | Impact −18° C. | | | | Bending | | | | |
| | Charpy unn. | | Charpy n. | | stress | | Modulus | | |
| | [kJ/m²] | | [kJ/m²] | | 3.5 [MPa] | | [GPa] | | Shore D |
| Material | Average | STD | Average | STD | Average | STD | Average | STD | Average |
| Sample 1 | 24.3 | 4.3 | 2.7 | 0.2 | 55.3 | 0.4 | 2.5 | 0.1 | 66 |
| Sample 2 | 20.6 | 2.7 | 2.1 | 0.3 | 40.6 | 0.4 | 1.7 | 0.03 | 64 |
| Sample 3 | 31.1 | 5.5 | 3.3 | 0.3 | 60.6 | 0.1 | 2.77 | 0.01 | 67 |
| Sample 4 | 32.8 | 1.6 | 2.4 | 0.2 | 42.7 | 0.7 | 1.83 | 0.05 | 64 |
| Sample 5 | 18.2 | 2.9 | 2.9 | 0 | 60.6 | 0.3 | 2.88 | 0.01 | 65 |
| Sample 6 | 22.9 | 1.6 | 1.8 | 0.5 | 42.6 | 0.4 | 1.84 | 0.02 | 63 |
| Sample 15 | 44.8 | 3 | 2.9 | 0.1 | 44.2 | 0.2 | 1.83 | 0.01 | 64 |
| Sample 17 | 29 | 1.8 | 3.6 | 0.4 | 48.6 | 0.5 | 2.54 | 0.05 | 61 |
| Sample 18 | 24.7 | 2.3 | 2 | 0.4 | 25.3 | 0.1 | 1.05 | 0.01 | 58 |

### Example 6

Fibers, polypropylene and bonding agent were dosed together into an internal kneader (Harburg Freudenberger Type GK 5 E, filling volume 5.5 l) in the proportions given in Table 4. They were kneaded at 136 revolutions per minute until at least the melting temperature of PP of 166° C. was reached. After reaching the melting temperature, revolutions per minute were reduced and the mixture was kneaded for further 6 to 10 minutes. The kneading mixture was discharged in one piece and was split by hand into pieces of about 5 cm in diameter and 15 to 25 cm length. After cooling, the pieces were granulated on a cutting mill equipped with a sieve with 5 mm holes. The resulting granulate was injection-molded (Arburg 420 C) to test pieces (dog bones). The test pieces were measured for tensile E-modulus, tensile strength, tensile elongation and impact strength (see Table 5).

TABLE 5

| | Charpy | Tensile- | Tensile | |
|---|---|---|---|---|
| | notched | E-modulus | strength | Elongation |
| Trial number | [kJ/m²] | [MPa] | [MPa] | [%] |
| PP HC205 TF | 3.7 | 1770 | 37.7 | 8 |
| 7 | 2.93 | 2217 | 39.6 | 8.5 |
| 8 | 2.79 | 2154 | 38.2 | 13.5 |
| 9 | 3.53 | 2072 | 33.7 | 15.6 |
| 10 | 3.35 | 2144 | 36.8 | 14.3 |
| 11 | 4.11 | 3123 | 45.5 | 5 |
| 12 | 4.57 | 3211 | 29.6 | 6.4 |
| 13 | 4.03 | 2839 | 38 | 7.3 |

The value in bold print was taken from the data sheet of the producer; all other values were determined according to DIN EN ISO-179-1 and DIN EN ISO 527/1/2/3.

TABLE 4

| | Loading | | Density | Concen- | | | | Concen- | | |
|---|---|---|---|---|---|---|---|---|---|---|
| | content | | [g/cm³] | tration | Amount | | Density | tration | Moisture | Amount |
| Trial # | [%] | Polymer | default HF | [%] | [kg] | Fiber type | [g/cm³] | [%] | [%] | [kg] |
| 7 | 75 | PP Homo | 0.95 | 68 | 2.805 | MDF ihd SCS 071 >6 mm | 1.5 | 30.00 | 0 | 1.238 |
| | | C205TF MFR 4 | | | | | | | | |
| 8 | 75 | PP Homo | 0.95 | 88 | 3.63 | MDF ihd SCS 071 >6 mm | 1.5 | 10.00 | 0 | 0.413 |
| | | HC205TF MFR 4 | | | | | | | | |
| 9 | 75 | PP Homo | 0.95 | 88 | 3.63 | MDF ihd SCS 071 >6 mm, | 1.5 | 10.00 | 0 | 0.413 |
| | | HC205TF MFR 4 | | | | Tempered at 200° C. | | | | |
| 10 | 75 | PP Homo | 0.95 | 88 | 3.63 | MDF ihd SCS 071 >6 mm, | 1.5 | 10.00 | 0 | 0.413 |
| | | HC205TF MFR 4 | | | | Tempered at 200° C. | | | | |
| 11 | 75 | PP Homo | 0.95 | 88 | 3.63 | MDF ihd SCS 071 >6 mm, | 1.5 | 10.00 | 0 | 0.413 |
| | | HC205TF MFR 4 | | | | Tempered at 200° C. | | | | |
| 12 | 70 | PP Homo | 0.95 | 68 | 2.618 | MDF ihd SCS 071 >6 mm, | 1.5 | 30.00 | 0 | 1.155 |
| | | HC205TF MFR 4 | | | | Tempered at 200° C. | | | | |
| 13 | 70 | PP Homo | 0.95 | 68 | 2.618 | MDF ihd SCS 071 >6 mm, | 1.5 | 30.00 | 0 | 1.155 |
| | | HC205TF MFR 4 | | | | Tempered at 200° C. | | | | |

| Trial # | Loading content [%] | Bonding agent | Density [g/cm³] | Concentration [w/w] | Amount [kg] |
|---|---|---|---|---|---|
| 7 | 75 | Scona TPPP 8112 FA | 0.9 | 2 | 0.083 |
| 8 | 75 | Scona TPPP 8112 FA | 0.9 | 2 | 0.083 |
| 9 | 75 | Scona TPPP 8112 FA | 0.9 | 2 | 0.083 |
| 10 | 75 | Kraton D 1184 ASM | 0.9 | 2 | 0.083 |
| 11 | 75 | Kraton FG 1901 GT | 0.9 | 2 | 0.083 |
| 12 | 70 | Kraton D 1184 ASM | 0.9 | 2 | 0.077 |
| 13 | 70 | Kraton FG 1901 GT | 0.9 | 2 | 0.077 |

MDF: refined fiber from spruce wood normally used to make MDF-board.
Ihd: Institut fur Holztechnologie, Dresden
SCS 071: internal number at ihd
Scona TPPP 8112 FA: bonding agent based on MAA-grafted polypropylene
Kraton FG 1901 GT: Impact modifier grafted with MAA
Kraton D 1184 AASM: Impact modifier without MAA

1. A single-step process for the production of fiber-reinforced thermoplastic compounds, comprising: compounding discontinuously with internal kneaders fiber agglomerates of biological or organic, natural or synthetic origin and thermoplastic resins whereby the fiber agglomerates are dispersed into single fibers and the single fibers are distributed homogeneously in the thermoplastic matrix.

2. The process of claim 1, wherein the fiber agglomerates consist of fibrillated fiber bundles, the starting fibers before fibrillation showing a diameter of from 10 to 20 μm, and the fibrils showing average diameters which are 5 to 250 times smaller than those of the starting fibers.

3. The process of claim 2, wherein the fibrils show average diameters which are smaller by a factor of 10 to 200 than those of the starting fibers.

4. The process of claim 3, wherein the fibrils show average diameters which are smaller by a factor of 30 to 80 than those of the starting fibers.

5. The process of claim 2, wherein the fibrillated fiber bundles show a specific surface area (measured according to the BET method) of from 1.0 to 60 m²/g.

6. The process of claim 5, wherein the fibrillated fiber bundles show a specific surface area (measured according to the BET method) of from 6 to 50 m²/g.

7. The process of claim 6, wherein the fibrillated fiber bundles show a specific surface area (measured according to the BET method) of from 8 to 16 m2/g.

8. The process of claim 1, wherein the fiber agglomerates comprise three-dimensionally entangled long-fibers having a length of at least 30 mm.

9. The process of claim 8, wherein the fiber agglomerates comprise three-dimensionally entangled long-fibers having a length of more than 50 mm.

10. The process of claim 1, wherein the fiber agglomerates consist of aramid, polyacrylonitrile (PAN), natural or synthetic cellulose fibers, or mixtures of two or more thereof.

11. The process of claim 10, wherein the aramid is a para-aramid.

12. The process of claim 10, wherein the natural or synthetic cellulose fibers are selected from hemp, flax, pulp, paper or Lyocell fibers.

13. The process of claim 10, wherein the natural or synthetic cellulose fibers are selected from Viscose or Rayon.

14. The process of claim 1, wherein the fiber content is 3 to 80% by weight.

15. The process of claim 14, wherein the fiber content is 10 to 50% by weight.

16. The process of claim 15, wherein the fiber content is 15 to 35% by weight.

17. The process of claim 1, wherein the thermoplastic resin is selected from the group consisting of polyolefin resins and their co-polymers; polyamides (PA) and their co-polymers;
styrene based polymers and their co-polymers; cellulose derivatives; polyesters and their derivatives;
polymethacrylates; bio-polymers; and a mixture of two or more thereof.

18. The process of claim 17, wherein the polyolefin is polyethylene or polypropylene.

19. The process of claim 17, wherein the styrene based polymer is polystyrene (PS), acrylonitrile-butadiene-styrene (ABS) or acrylic ester-styrene-acrylonitrile (ASA).

20. The process of claim 17, wherein the cellulose derivative is cellulose acetate (CA).

21. The process of claim 17, wherein the polyester is polyester terephthalate (PET).

22. The process of claim 17, wherein the polymethacrylate is polymethyl methacrylate (PMMA).

23. The process of claim 17, wherein the bio-polymer is polylactic acid (PLA).

24. A thermoplastic composite obtained by the process of compounding discontinuously with internal kneaders fiber agglomerates of biological or organic, natural or synthetic origin and thermoplastic resins whereby the fiber agglomerates are dispersed into single fibers and the single fibers are distributed homogeneously in the thermoplastic matrix, wherein the composite has a tensile E-modulus increased at least by 25%, relative to the not reinforced matrix polymer; and an impact strength increased by a factor of 1.1 to 10, relative to the not reinforced matrix polymer.

25. The thermoplastic composite of claim 24, wherein the tensile E-modulus is increased by at least 50%, relative to the not reinforced matrix polymer.

26. The thermoplastic composite of claim 25, wherein the tensile E-modulus is increased by at least 100%, relative to the not reinforced matrix polymer.

27. The thermoplastic composite of claim 24, wherein the impact strength is increased by a factor of from 1.2 to 8, relative to the not reinforced matrix polymer.

28. The thermoplastic composite of claim 27, wherein the impact strength is increased by a factor of from 2 to 5, relative to the not reinforced matrix polymer.

29. A thermoplastic composite obtained by the process of compounding discontinuously with internal kneaders fiber agglomerates of biological or organic, natural or synthetic origin and thermoplastic resins whereby the fiber agglomerates are dispersed into single fibers and the single fibers are distributed homogeneously in the thermoplastic matrix, wherein the composite is provided for further processing in the form of particles having diameters of from 2 mm to 15 mm.

30. The thermoplastic composite of claim 29, wherein the composite is provided for further processing in the form of particles having diameters of from 3 mm to 8 MM.

31. The thermoplastic composite of claim 30, wherein the composite is provided for further processing in the form of particles having diameters of from 4 mm to 6 mm.

32. A thermoplastic composite obtained by the process of compounding discontinuously with internal kneaders fiber agglomerates of biological or organic, natural or synthetic origin and thermoplastic resins whereby the fiber agglomerates are dispersed into single fibers and the single fibers are distributed homogeneously in the thermoplastic matrix, wherein the composite is provided for further processing in the form of panels or sheets.

33. The thermoplastic composite of claim 32, wherein the composite is provided for further processing in the form of panels or sheets having a thickness of from 0.2 mm to 15 mm.

34. The thermoplastic composite of claim 33, wherein the composite is provided for further processing in the form of panels or sheets having a thickness of from 0.5 mm to 10 mm.

35. The thermoplastic composite of claim 34, wherein the composite is provided for further processing in the form of panels or sheets having a thickness of from 1 mm to 6 mm.
